(19) United States
(12) Patent Application Publication
(10) Pub. No.: US 2007/0174143 A1
(43) Pub. Date: Jul. 26, 2007

(54) XML based internet and browser system and method

(76) Inventors: Shrage Smilowitz, Monroe, NY (US); Aron Markowitz, Monroe, NY (US)

Correspondence Address: Glen M. Diehl;DIEHL SERVILLA LLC, Suite 110, 77 Brant Ave., Clark, NJ, 07066, US

(21) Appl. No.: 11/656,235

(22) Filed: Jan. 22, 2007

Related U.S. Application Data
(60) Provisional application No. 60/761,098, filed on Jan. 23, 2006.

(51) Int. Cl. G06F 17/30

(52) U.S. Cl. 705/27; 705/26

(57) ABSTRACT

The present invention, in accordance with one aspect, provides a new system and method for linking to internet files wherein a variety of options are presented. In accordance with another aspect of the present invention, a new architecture for a web site as well as systems and methods for providing communications with a web site using xml files is provided. In accordance with yet another aspect of the present invention, systems and methods to provide improved services over the Internet are provided.

### CROSS-REFERENCE TO RELATED APPLICATIONS

This application claims the benefit of U.S. Provisional Application No. 60/761,098, filed Jan. 23, 2006, which is incorporated herein by reference.

### BACKGROUND OF THE INVENTION

The present invention relates to a system and method for providing communications and services via the Internet.

Existing communications and services provided on the Internet are largely based on HTML protocols. The systems and methods that provide the communications and services have many limitations. For example, from a user's perspective, a user needs to determine how each site works. Even if customization of the site is permitted, a user needs to customize each site individually. Further, some tools are available on one site, while other tools are available on a different site. This can make Internet usage time consuming.

Many sites provide a shopping cart function, but the shopping cart is not in the user's control. Thus, by way of example, when a user leaves a shopping cart, the user is never sure what will stay in the shopping cart. It is possible that all of the information can be lost. Further, it is not possible to have an overview of all of a user's shopping carts meaning those shopping carts in different web sites because this information is maintained separately at individual sites.

Linking can also be clumsy on the Internet, particularly if one is looking for information. There is no way to link to just information. A user must link to a whole page so that the user must open a window to see the link and then click on the link to see the information.

Searching also can be problematic on the Internet. For example, a typical search engine indexes all of the words on a site and tries to determine the subject of the site. Specific fields such as price, manufacturer, and description cannot typically be searched. Also searching only allows one to search for pages that mention a keyword so that intelligent functions, such as comparing results, cannot be accomplished. The ability to compare products must be implemented manually by individual sites.

Security is a big issue with the Internet. Typically when a user enters a web page, the user can never be sure what will happen because the site is sending an application to the user. This is true even with today's anti-virus software applications because, each day, new vulnerabilities are found and it's impossible to see those in advance.

Tracking transactional histories and receipts with purchases can also be problematic on today's Internet. Each site on the Internet has its own way of giving receipts and how and if its stores transactional logs. Some sites give receipts in HTML to be printed while others send emails. A user needs to track all of the receipts and where they are stored to track transactional history of purchases. This also creates problems for a user who forgets where and when a purchase over the Internet was made.

Managing information is another problem area. Information that is stored is typically stored by a site owner. A user does not have control over that information, cannot search by the information and cannot move the information as if the user would control the information.

When buying items over the Internet, it is often desirable to send a notification of some kind. For example, notifications like reorders, inventory updates, price changes and the like are often transmitted. Each site on the Internet handles these differently, if they provide notifications at all. This is an inconvenience and creates problems for the users.

Finally, building web sites that allow sites to provide services is expensive and can be time consuming. A programmer is needed, a design is needed and, most importantly, money is required. It would be preferable to simplify the process of building web sites that could provide services via the Internet.

Thus, new and improved methods and systems to provide communications and services via the Internet are needed.

### SUMMARY OF THE INVENTION

The present invention, in accordance with one aspect, provides a new system and method for linking to internet files. In accordance with another aspect of the present invention, a new architecture for a web site as well as systems and methods for providing communications with a web site is provided. In accordance with yet another aspect of the present invention, systems and methods to provide improved services over the Internet are provided.

In accordance with one aspect of the present invention, a method of linking to internet files is provided. The method involves viewing information from a web site specified by a link in a file and then selectively saving information from the web site in accordance with one of the several options. The options include saving only the link, saving a copy of the information and the link and saving only the information.

The present invention, preferably through a browser, also allows users to view links in a combined way. Thus, if a document links to a piece of another document, the browser and or server combines it and displays it to the user as one, and gives the user the options to 1) automatically combine it, or 2) show an icon that this link has more information, and based on a user's action, show the content of that link source.

The selection is preferably made from a software application of a computer connected to an Internet-connected web site. The software application can be a browser. In accordance with one aspect, the software application causes the information to be saved in a storage medium local to the computer. Alternatively, the software application causes the information to be saved in a storage medium remote from the computer. The content source may be a web site on the Internet or local content.

In accordance with a preferred embodiment of the present invention, the file specified by the link is in xml format.

Another aspect of the present invention contemplates a system for linking to internet files. The system includes a first means for causing information from a web site specified by a link in a file to be viewed and a second means for causing information from the web site to be saved in accordance with the previously identified options. The first and second means includes a computer system, such as a PC, and associated software to control the computer system.

Another aspect of the present invention provides a web site. The web site includes a processor and a storage medium connected to the processor. The web site also includes one or more files in xml format that specify the web site and one or more types of services available at the web site and one or more files in xml format that specify the specific services available for each of the types of services. Alternatively, all of the information described in this paragraph can be provided in a single xml file.

The types of services include providing news, banking and selling products as well as other products and services provided on the Internet. The types of services can also include a list of a plurality of products available from the web site. A description of each of the plurality of products can be included in the specific services.

A file that specifies a type of software utility and version of software utility that can read the one or more files in xml format is preferably provided. The file also preferably specifies the web site and one or more types of services available at the web site and the specific services available for each of the types of available service. Alternatively, this information can be provided in one file in addition to the previously mentioned information.

In accordance with another aspect of the present invention, a method for a web site to communicate is provided. The method includes transmitting one or more files in xml format that specify the web site and one or more types of services available at the web site and transmitting one or more files in xml format that specify the specific services available for each of the types of services. Again, all of this information can be provided in a single xml file that is transmitted.

The present invention also contemplates receiving an xml file with this transmitted information and displaying the information on a computer. In accordance with one embodiment of the present invention, a browser receives the transmitted information.

In accordance with a further aspect of the present invention, a computer is provided that communicates with a web site. The computer includes a processor, a storage medium that communicates with the processor and a software application operable on the processor. The software application is operable to send a request to the web site and receive at least a portion of one or more files in xml format that specify the web site and one or more types of services available at the web site and receive at least a piece of one or more files in xml format that specify the specific services available for each of the types of services.

The types of services include providing news, banking and selling products. The specific services include a list of a plurality of products available from the web site. A description of each of the plurality of products is included in the specific services. The types of services include selling products and the specific services includes a list of a plurality of products available from the web site and a description of each of the plurality of products is included in the specific services.

In accordance with a further aspect of the present invention, the computer further includes a display and the software application enables viewing of the list of plurality of products on the display. The software application can also enable viewing of the description of each of the plurality of products on the display. The software application can also create a wish list from the plurality of products and stores the wish list in the storage medium. The software application can also sort the plurality of products and displays a sorted list of the plurality of products. The software application can also filter the plurality of products in accordance with parameters associated with the products and display a filtered list of the plurality of products.

The software application can also be operable to send a second request to a second web site, receive at least a portion of one or more files in xml format that specify a plurality of products available at the second web site, and a description of each of the plurality of products available at the second web site, and to create a comparison of the plurality of products available at the web site and the plurality of products available at the second web site.

### DESCRIPTION OF THE DRAWINGS

FIG. 1 illustrates an Internet based system.

FIG. 2 illustrates a method of saving a link and information specified by the link in accordance with a plurality of options.

FIG. 3 illustrates a screen provided to a user in accordance with one aspect of the present invention.

FIG. 4 illustrates a web site architecture in accordance with one aspect of the present invention.

FIG. 5 illustrates a system and method of retrieving product information from one or more Internet sites in accordance with one aspect of the present invention.

FIGS. 6 and 7 illustrate a plurality of xml files in accordance with one aspect of the present invention.

FIGS. 8 to 14 illustrate a set up for a server in accordance with one aspect of the present invention.

FIG. 15 illustrates a system and method of creating a wish list in accordance with an aspect of the present invention.

FIG. 16 illustrates a system and method of obtaining linked product information from multiple sites on the Internet in accordance with an aspect of the present invention.

FIG. 17 illustrates a system and method of comparing information obtained from the Internet concerning a product.

FIG. 18 illustrates the comparison of products obtained as a result of the system and method illustrated in FIG. 7.

FIGS. 19 to 21 illustrate various screen shots provided by a browser in accordance with one aspect of the present invention.

FIG. 22 illustrates a browser in accordance with another aspect of the present invention.

### DESCRIPTION OF THE PREFERRED EMBODIMENT

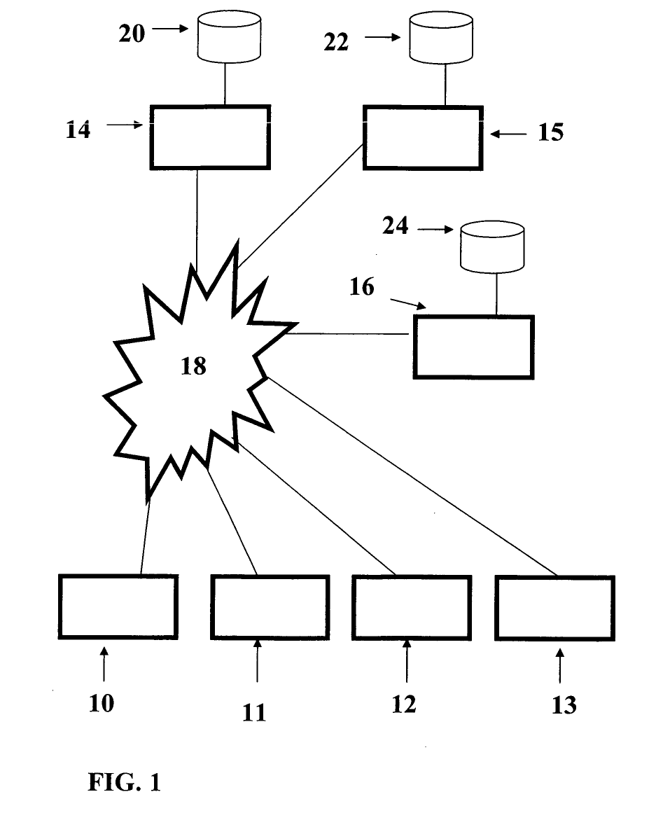

FIG. 1 illustrates an Internet based system. A plurality of terminals 10 to 16 are connected to the Internet 18. The terminals 10 to 13 are accessed by individuals and the terminals 14 and 15 are servers maintained by businesses and information providers. A database or other storage medium element 20 is connected to the terminal 14 and a database or other storage medium element 22 is connected to the terminal 15. Information and HTML based web pages are typically stored in the databases 20 and 22. The terminal 16 may be a server maintained by a service provider and database 24 can be stored.

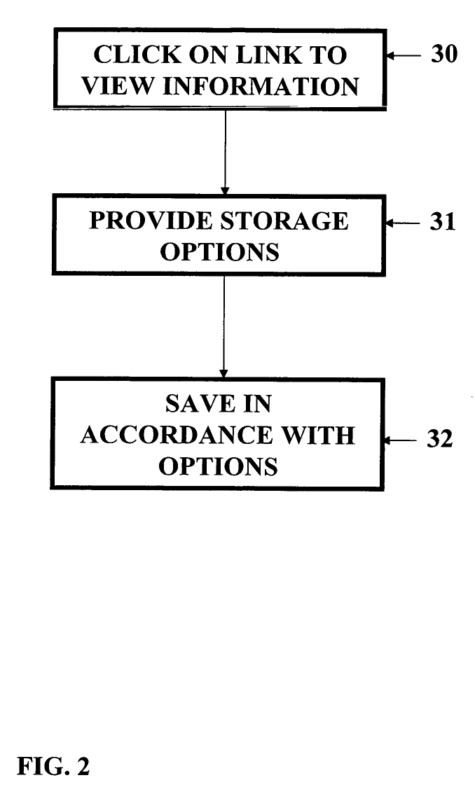

In accordance with one aspect of the present invention, a method of linking to internet files is provided. A user on one of the terminals 10 to 13 accesses a web site maintained on the servers 14 or 15. As shown in FIG. 2, in step 30, the information from a web site maintained on the servers 14 or 15 specified by a link in a file is viewed. This step 30 is well known. In step 31, a software application on the terminals 10 to 13 provides a user with several options on how to store the associated information. In step 32, the application software causes the information associated with the specified link to be saved in accordance with the options selected by the user. In accordance with a preferred embodiment of the present invention, the following options are presented by the application software: saving only the link; saving a copy of the information in the file and the link; and saving only the information in the file.

The software application can be a browser. The software application preferably provides an option for each web site visited.

The information and/or the link, in accordance with the specified option, can be saved in a storage medium local to the computer 10 to 13. Alternatively, the software application can cause the information and/or the file to be saved in a storage medium remote from the computer in accordance with the specified option.

In accordance with one aspect of the present invention, the file referred to in the link is in xml format.

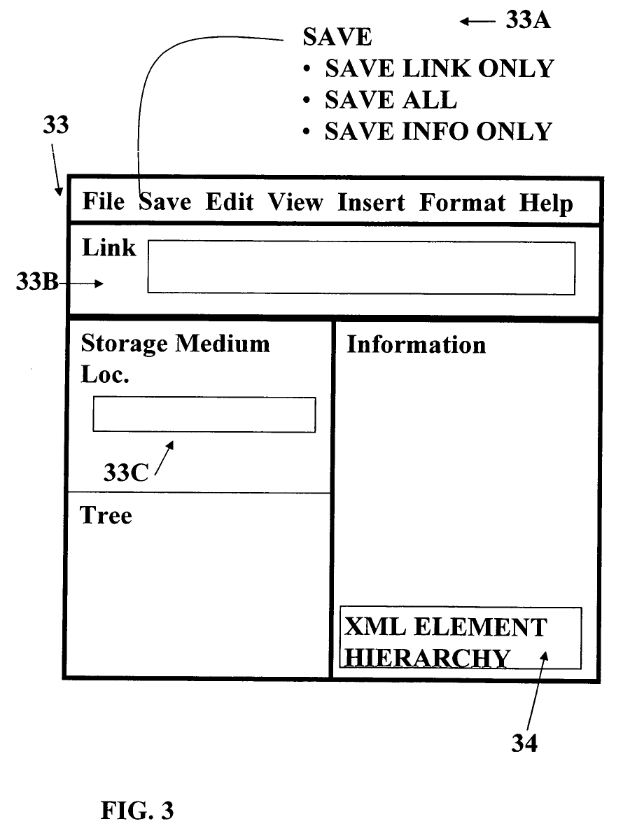

A screen that is provided on a user's computer, preferably by a browser application is illustrated in FIG. 3. A menu bar 33 is provided. The standard items in a menu can be provided. A SAVE menu command is preferably placed in the edit menu, but it could be provided anywhere or could be a command button located elsewhere. When the EDIT menu item is clicked, a list of various submenu options is provided, including by way of example only, UNDO, CUT, COPY PASTE and the SAVE menu command. The SAVE menu command specifies the options for saving information are provided underneath the SAVE menu item. The list of submenu options is illustrated as 33A and includes SAVE LINK, SAVE SNAPSHOT, and MERGE. A save function can also be performed by dragging a selection into a storage folder.

The link to the web site being viewed is specified in a text box at 33B. Another text box 33C is provided. The location of the storage medium that the information is to be stored in is specified in text box 33C.

Alternatively and preferably, however, the location of the storage medium, is stored in the browser settings section, and it goes together with the login. This way the browser knows where to store, history, receipts and all other storage that happens automatically. The location of the storage medium is preferably in a central provider on the internet.

When the SAVE LINK menu item (or other control item such as a command button) is selected, the software application that caused the screen in FIG. 3 to be displayed obtains the link information from the current selection on the screen and stores that link in a storage medium located at the address specified in the configuration settings sections to the current login. That location can either be local to the computer that the information is displayed on or can be remote to that computer. When the SAVE INFO menu item (or other control item) is selected, the software application obtains the information (at least part of which is being displayed in the right hand side of the screen) and stores that information in a storage medium located at the address specified in text box 33C. When the SAVE ALL menu item (or other control item) is selected, the software application obtains the information and the link and stores that information in a storage medium located at the address specified in text box 33C.

Of course, the options for saving can be provided in a number of additional ways. For example, a group of command buttons can be provided on the screen for the user to select. Saving would then be implemented in accordance with the selected command button.

In accordance with one aspect of the present invention, the information in the right hand portion of the screen is displayed from a xml file. The screen of FIG. 3 also includes a text box 34 that specifies the hierarchical xml format of information from the displayed information.

A system for linking to internet files is provided. The system includes first means for causing information from a web site specified by a link to be displayed and second means for providing two or more options, the two or more options specifying what to save. It also includes third means for selecting one of the options and fourth means for saving information from the web site, the link or both in accordance with the selected option. Each of these means is provided by a software application that is operable on the processor 35.

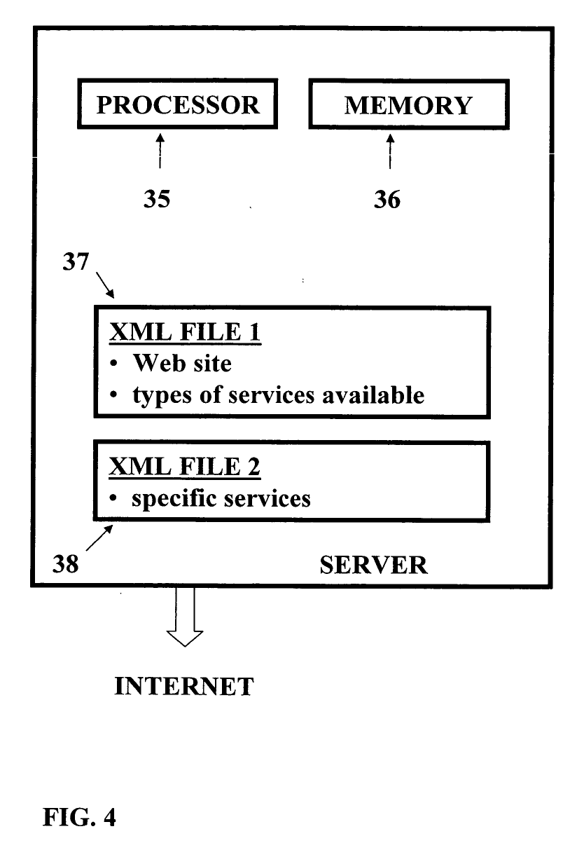

In accordance with another aspect of the present invention a web site is provided. The web site is maintained on any one of the servers 14 or 15. Referring to FIG. 4, the web site or the server 14 includes a processor 35 and a storage medium 36 connected to the processor as is well known. In accordance with one embodiment of the present invention, the storage medium stores one or more files 37 and 38 in xml format that specify the web site and one or more types of services available at the web site and stores one or more files in xml format that specify the specific services available for each of the types of services. In an alternative embodiment, all of this information can be provided in a single file, preferably in xml format.

The types of services can include providing news and selling products. Other types of services can also be included. By way of example, album listings, forms and messaging can also be provided.

In accordance with one aspect of the present invention, where the type of service available is selling products, the file that specifies the specific services available includes a list of a plurality of products available from the web site. A description of each of the plurality of products can also be included in the specific services. The description can include that product name, the product description, size, color, price as well as other information about the product or manufacturer. The product description can be provided by a link to the manufacturer's web site, thereby obviating the need to write a separate product description.

The information provided in xml format can be provided in two files 37 and 38, a single file or more than two files.

A file that specifies a type of software utility that can read the one or more files in xml format that specify the web site and one or more types of services available at the web site and that can read the one or more files in xml format that specify the specific services available for each of the types of services can also be provided.

In accordance with another aspect of the present invention, a method for a web site to communicate is provided. In a first step, one or more files in xml format that specify the web site and one or more types of services available at the web site are transmitted. The transmission is made in response to a request for services from a user on the internet. In a second step, one or more files in xml format that specify the specific services available for each of the types of services are transmitted. The information transmitted can be an entire file or a portion of the file. Alternatively, these steps can be performed as a single step wherein the information is contained in one or more files that are transmitted in a single step.

The types of services specified in the file includes providing news, selling products, album listing, forums and messaging. As before, the specific services can include a list of a plurality of products available from the web site and a description of each of the plurality of products can be included in the specific services.

The method can also include the step of transmitting a file that specifies a type of software utility that can read the one or more files in xml format that specify the web site and one or more types of services available at the web site and that can read the one or more files in xml format that specify the specific services available for each of the types of services.

Communications with the servers 14 and 15 suffer from the drawbacks previously mentioned. In accordance with one aspect of the present invention, XML files are created at one or more sites, such as at servers 14 and 15. The created XML files are then used to communication information and to provide services.

XML is a known standard. It stands for Extensible Markup Language. XML was designed to describe data. XML is a markup language like HTML, but XML tags are not predefined. Instead a user defines their own tags. Thus, XML is self describing and extensible. XML uses a DTD (Document Type Definition) or an XSD to formally describe data. In general, XML is not a replacement for HTML and XML and HTML were designed with different goals. XML was designed to describe data and to focus on what data is whereas HTML was designed to display data and to focus on how data looks.

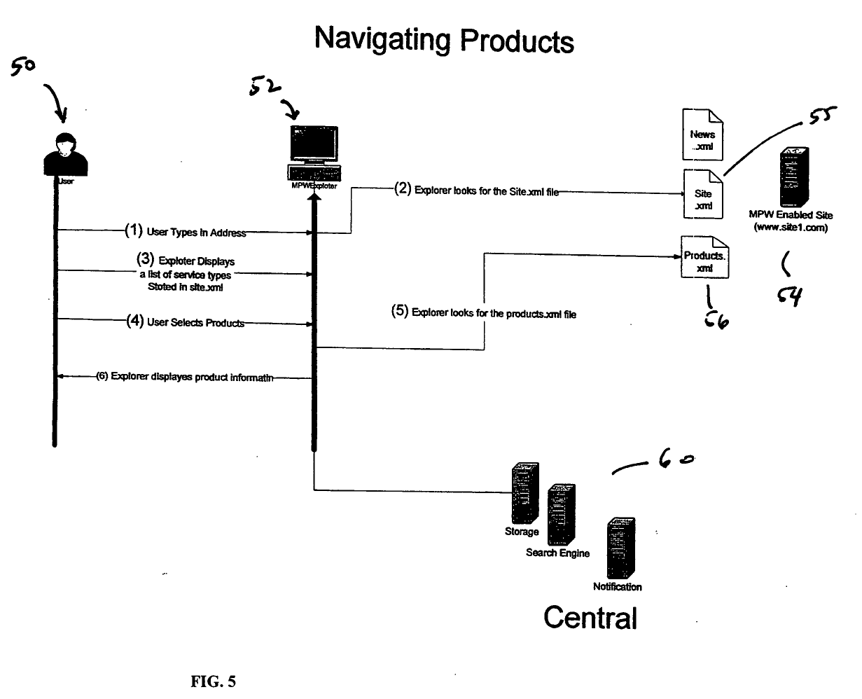

Referring to FIG. 5, a system and method for navigating products in accordance with one aspect of the present invention is illustrated. A user 50 at a terminal 52 communicates with a site 54 via the Internet. The site 54 is enabled in accordance with a convention specified in accordance with one aspect of the present invention. The site 54 maintains a number of XML files. A site.xml file provides a list of services provided by the site 54. A products.xml file describes products that are offered through the site. The description, as previously described, can include a product name, a description, color, size, price, etc. Further, this information can be provided in a single xml file or in more than two xml files.

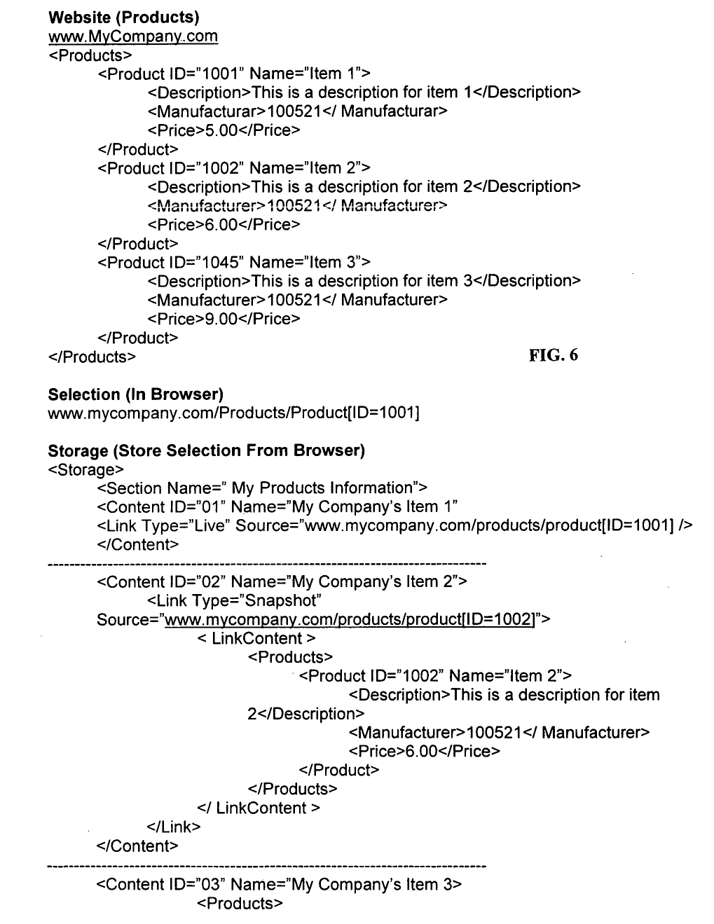

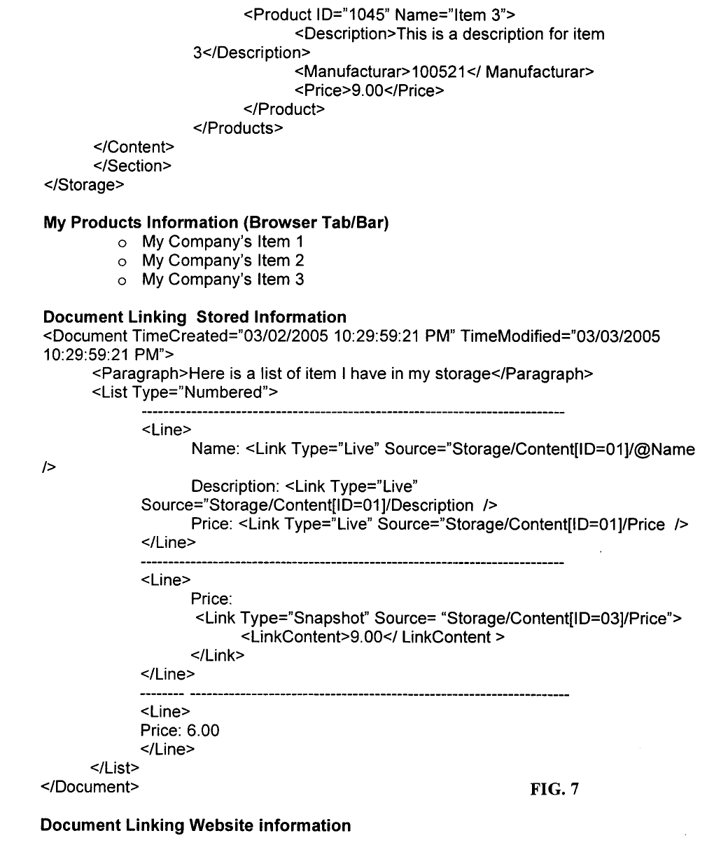

FIGS. 6 and 7 are representative of xml files 37 and 38 in accordance with one aspect of the present invention. The information provided includes a list of products available in the My Products Information section and a list of product descriptions in the WEB SITE (PRODUCTS) section. It also includes information about linked information.

In accordance with one aspect of the present invention, a method and system for navigating products is provided. Referring to FIG. 5, in step (1) the user 50 types in an address into the terminal 52. The address is preferably typed into a browser. The browser on the terminal 52 uses the address to search for a site at the specified address on the Internet in step (2). The site 54 responds by sending the site.xml file to the terminal 52 and the terminal 52, in step (3), displays a list of services derived from the site.xml file. In step (4), the user 50 selects products of interest, and in step (5), the terminal 52 accesses the step 54 via the Internet to search for the products.xml file. This file is sent to the terminal 52 and the terminal 52 extracts information relating to the selected products of interest. Of course, as previously mentioned, the information in the site.xml file and in the products.xml file can be combined into a single file. Also, all or part of a file can be transmitted.

The browser stored on the terminal 52 is different than the browsers found on today's computers, such as Internet Explorer or Netscape, which operate on HTML codes. The functionality of the browser stored on the terminal 52 is to provide a platform to browse web sites and content of a given web site. A web site is an online site that belongs to a specific organization described in the site.xml file. The site can reside on one web address or spread between multiple locations. After the browser recognizes the services and documents provided by the web site it will be responsible for the several actions, which are summarized in the following:

Messages: Sending and receiving the messages between the site server, central, browser and client application.

Static and Dynamic Content: Static content means the actual xml data and format of the data that the browser or the client expects to receive from the site. The site can create the content dynamically as long as the expected data is delivered.

If the client wants to receive dynamic content, for example it wants to search data using xPath, the browser will try to run that query against the server, if the server recognizes that query it will provide the resulting content, if the server does not understand it, the browser will receive the full static content and filter the content locally.

Launching the application: The browser launches an application on the client based on the service or document of the site. Since the browser will not be the actual application that provides functionality based on received content, the actual functionality will be provided by the specific application that knows how to read the content of the site. The browser will need to know what application to load. This will work almost how file extensions work in windows. MPW Central will have a database of all service types a site can provide, each service type will be linked to a client application id. When the browser first visits a site it will look for the service provided by the site, if it recognizes the type of service it will try to launch that application.

Message flow: After the browser launches the client application, it is still responsible to route all messages between the client app and the server, besides the Messages that the client sends directly to the browser, such as a call to Store data and the actual data to store.

Client requirements: XML path for each selected element I so the user can save it to the storage with Full Context information.

Documents: Manage documents provided by sites or applications Storage: Manage storage for the site, application and user. Storage can be provided at a central storage, a portable storage and storing content.

Authentication: Authenticate the user to get user's profile.

Profile: Direct profile information from central—web site and application

Search: Search site content, and stored content

The browser stored on the terminal 52 must be able to process xml files to perform all of these applications. The browser 52 should allow at least the following activities: Navigate; Search; Display; Filter; Selection; Link; Archive and Notification.

The browser 52 should include navigation tools, including an address bar, a tree view of services and sub elements, a custom templated view of services and sub elements. The browser 52 allows navigation between web sites, between services of each web site by providing an address bar where the user can type in an address location, or a location and filter statement. Alternatively, the browser can display an hierarchical view of services and element in a service, so the user can navigate by selecting a node in the tree, or navigation can be provided by a custom template as discussed in the viewing section.

The browser should provide search capabilities. The searching can be against the current web site viewed, or against the whole internet. The Search options are based on the schema type the user is searching by, so a list of options is displayed for the user such as Products, News, Music, Books etc. when a user selects an option, the appropriate search box is launched. Search options can be automatically displayed based on the schema currently viewed.

The browser 52 should be able to display information. The browser 52 preferably has different display views, based on the schema an appropriate view is launched. Preferably, there is a simple view for each schema, which displays just the data in an hierarchical and tabular view.

The browser 52 also preferably has a design view, which allows the user to specify a template to use for a specific schema.

The templates can be preset and pre-downloaded for a schema or downloaded on-demand meaning it's downloaded when viewing. By allowing on-demand downloads of templates, a site can specify a recommended template which points to a publicly available template, the browser may download such templates automatically if the user permits it in the browser user's settings.

The browser 52 preferably allows a user to switch between simple or design view.

The browser 52 preferably includes a view function. The view can be a whole list of elements, a list of elements resulting from a filter or a single element resulted from a filter.

The browser 52 also preferably includes a filtering function. In accordance with one aspect of the present invention, the filtering can be accomplished in an address bar and/or by a visual tool. In accordance with a preferred embodiment, filtering is done currently using Xpath and Xquery.

The browser 52 also preferably includes a selection function. A selection may be the whole list and it's recognized by its location. A selection may be a list resulted from a filter and it's recognized by it's xpath filter. A selection may be a partial list of elements within a filter result (it will be recognized as separate selections). A selection may be a single element and it's recognized by an ID sub element, or ID attribute. A selection may be a single or list of elements, which is recognized by the software automatically detecting filters and providing it for the user to select which filter to use as selection recognizer.

The browser 52 should also include a linking function. A link can be a static location such as an ID. A link can be a dynamic location such as a filter. A link result can be a single simple type element. A link result can be a single complex type element. A link result can be a group of elements (if the link if a dynamic link). A link display name can be a Custom Name. A link display name can be the text of a simple type. A link display name can be text of one of the elements of the result (if the result is a complex type).

This is preferably accomplished by providing an element list of the complex type element, which the user can select which one should be the display name. It is also preferred to use a filter tool to further filter the result to a single element and providing one of the options above.

The browser 52 also preferably provides a snapshot link. A snapshot link is something that can be manually updated. A snapshot link provides a user with an option when updating the content of the link, to purge the old version or to save it. The user can later recognize the versions by date. Using a snapshot link, the user can set a schedule on a stored link to automatically check if the content has changed, and update the content of the link. The user has the options to automatically save or to delete the old versions of the content.

The browser 52 preferably provides storage capabilities. Storage has special folders which can only accept elements from a specific schema, i.e., a wish list accepts only product items. Storage can also have a generic folder which accept links and content of any element. In accordance with one aspect of the present invention, storing can happen automatically such as a history of site navigation which is stored automatically in the storage, receipts of web sites are also stored in storage automatically.

Storage can also be connected with the login, so automatic storage can happen without the user's need to select a location. The construction of a browser 52 that is able to process xml files and to perform these functions is well known in the art.

Normally, the information relating to products and services at a site such as site 54 is stored in HTML files. In accordance with the present invention, however, the information is stored in XML files. In accordance with one aspect of the present invention, another site 60 is provided to manage various aspects of the present invention. One of the services provided by the site 60 is a wizard to allow sites such as site 54 to convert its HTML files to XML files.

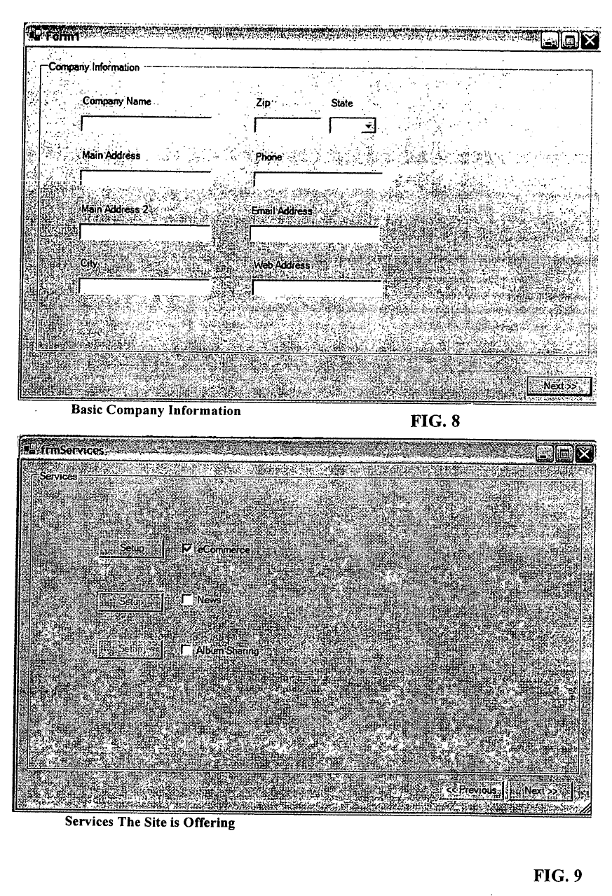

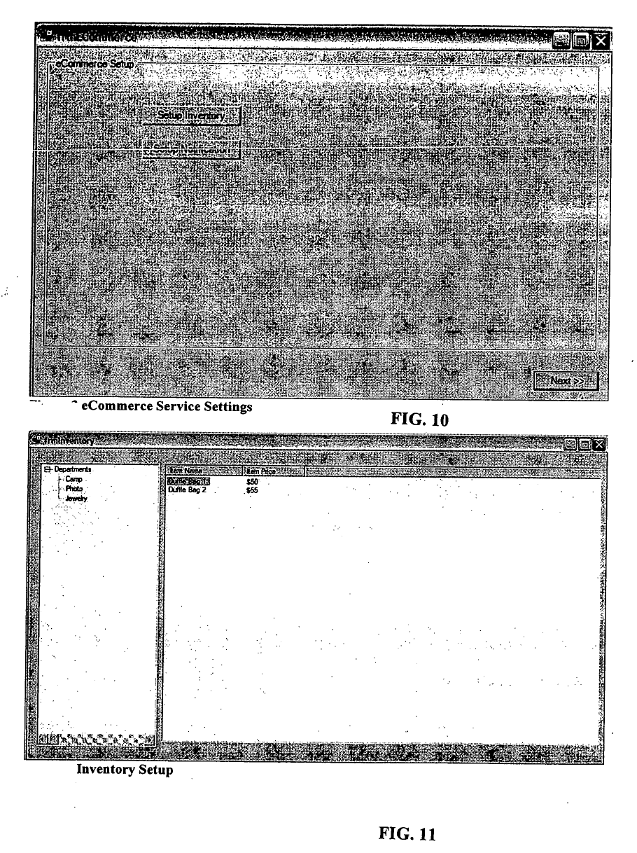

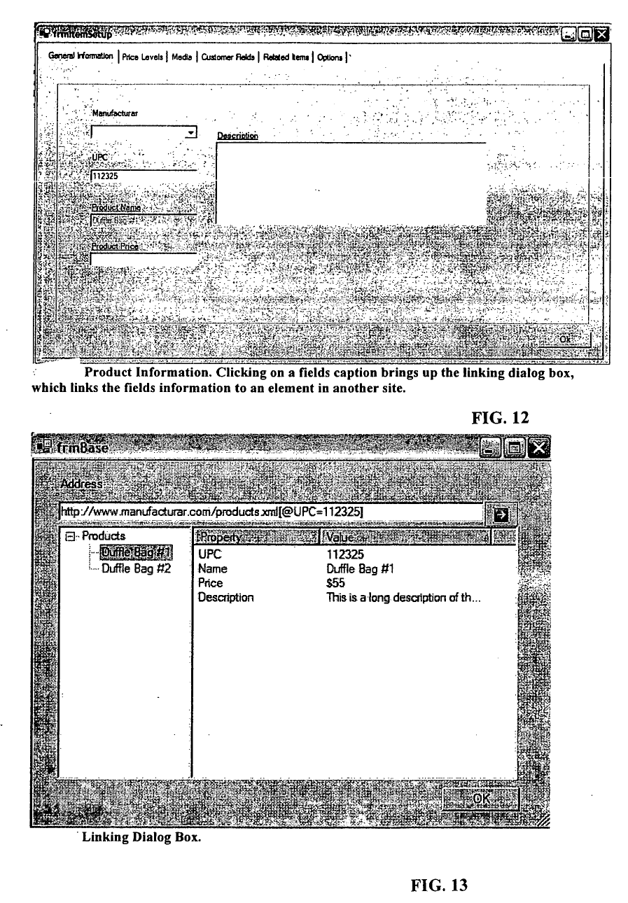

FIGS. 8 to 14 illustrate screens provided by the site 60 to allow web sites to set up their web sites to communicate in accordance with different aspects of this invention. FIG. 8 illustrates a window that allows the entry of basic information about the company offering the services. FIG. 9 illustrates the type of services that can be provided by the web site. In FIG. 9, the web site can offer eCommerce solutions, News and album sharing. FIG. 10 illustrates the initial screen for the eCommerce set up. The user can select either inventory set up or notification set up. FIG. 11 illustrates the inventory set up. A user can enter a product's name and the price, preferably but not necessarily by department. FIG. 12 illustrates a window in accordance with one aspect of the present invention wherein information about products can be entered. The information includes the manufacturer, the UPC code, a name, a price and a description. Clicking on one of the captions of a field brings up a linking dialog box that links the information in that field to an element in another site.

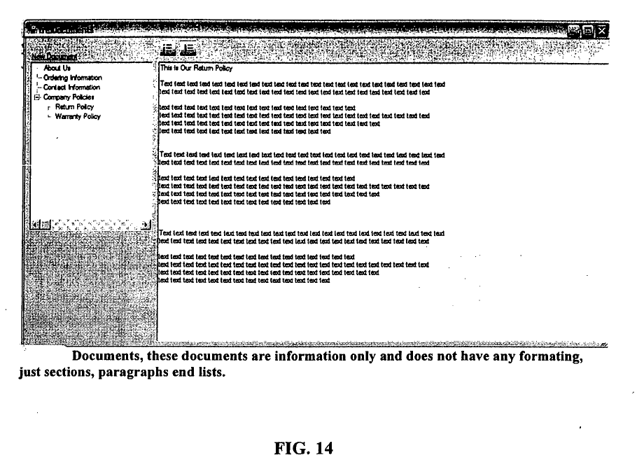

FIG. 13 illustrates the linking dialog box window that is opened when one of the fields in FIG. 12 is clicked. This window allows the specification of an address of the site to link to. This address will be, for example, a manufacturer's web site for the product being displayed in FIG. 12. FIG. 14 illustrates that there are various documents that can be provided by a web site offering products or services over the Internet in accordance with one aspect of the present invention.

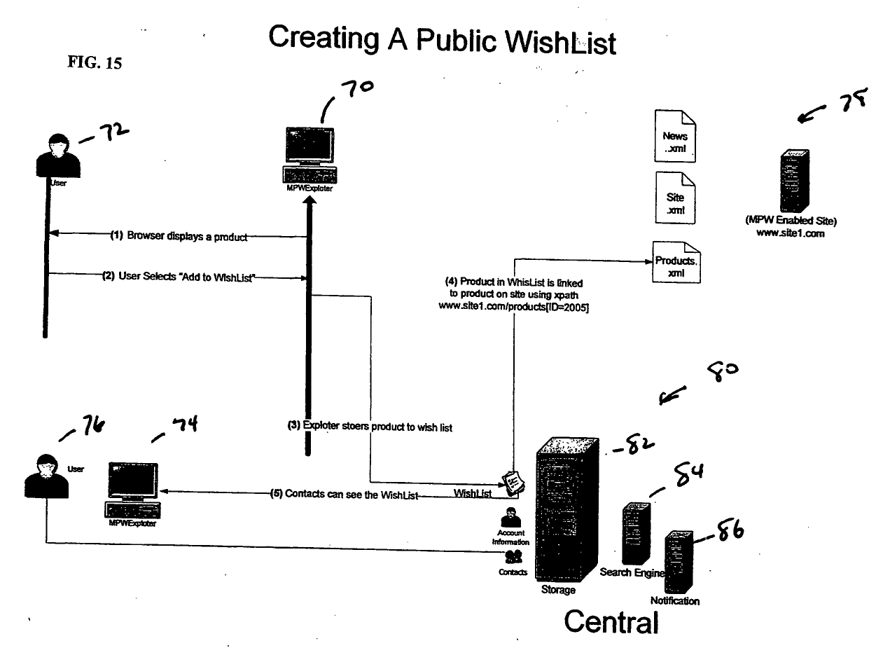

The present invention also provides a system and method for creating a wish list as illustrated in FIG. 15. The wish list allows a user to enter items or products that the user is interested in purchasing and also allows others to view the wish list and make purchases of those items. The illustrative system of FIG. 15 includes a first terminal 70 that is accessed by a first user 72 and a second terminal 74 that is accessed by a second user 76. The terminals 70 and 74 communicate via the Internet with a server 78 that offers products for sale. The terminals 70 and 74 as well as the server 78 communicate via the Internet with a central server 80. The server 78 can be any site offering a product, such as books, CDs etc., for sale. The central server 80 is maintained in accordance with one aspect of the present invention.

The server 78 is enabled in accordance with the teachings of the present invention. Thus, there is a site.xml file that indicates the services [available from the server 78] and there is a products.xml file that indicates information about the products that are available from the server 78.

As illustrated in FIG. 15, the server 80 preferably maintains a storage server 82, a search engine server 84 and a notification server 86. The storage server 82 maintains wish lists for various users, as explained above. The search engine server 84 is well known and provides searching capabilities of the internet. The notification server 86 tells users or subscribers to the services of the server 80 when a web site changes information on the web site. For example, a user can ask the notification server 86 to advise.

In accordance with this aspect of the present invention, referring to FIG. 15, the user 72 has requested product information from the server 78 and that information is displayed by a browser on the terminal 70 in step (1). The browser is the special browser that handles XML files and that was discussed previously. In step (2), the user 72 selects a product of interest and selects the “Add to Wish List” function on the browser. The Add to Wish List function can be implemented in a variety of ways. For example, the Add to Wish List function can be a command button, a menu item or a item on a toolbar. Once the user selects the Add to Wish List function, in step (3) the browser on the terminal 70 accesses the central server 80 to store the selected product in a Wish List file stored on the storage server 82. In step (4), the product specified in the Wish List is linked to the product on an external web site 78. This link is established and maintained when a user adds a product to his or her wish list.

In step (5), other users, such as user 76 on the terminal 74 can access the central server 80 to view the user's 72 Wish List. The user 76 accomplishes this by entering the address of the central server 80, selects the Wish List function and enters the user's 72 name. The central server 80 then accesses the user's 72 Wish List in the storage server 82 and presents that Wish List to the user 76 on the terminal 74.

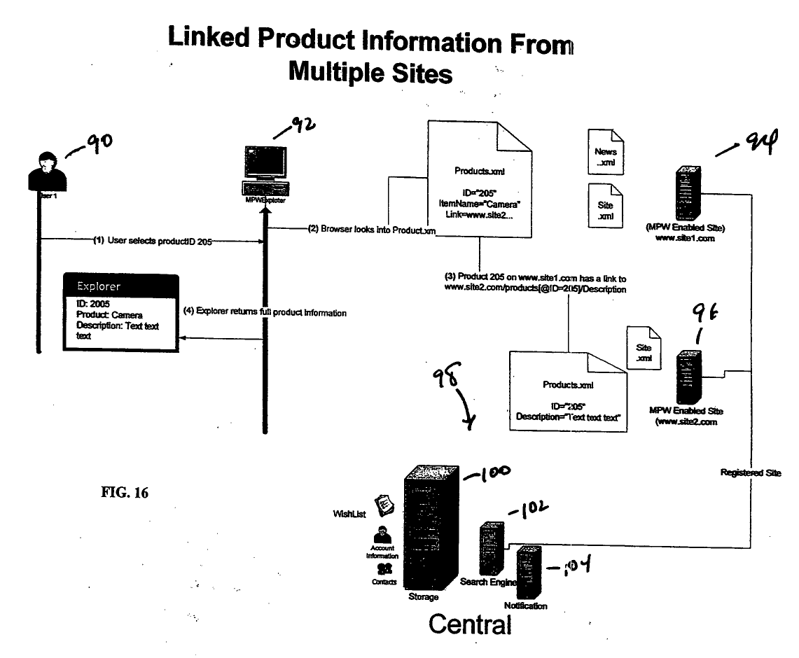

FIG. 16 illustrates a system and method for linking information from multiple Internet sites in accordance with one aspect of the present invention. A user 90 accesses the Internet via a terminal 92. A server 94, a server 96 and a system server 98 also access the Internet. The server 98 is a central server with a storage server 100, a search engine server 102 and a notification server 104. The servers 94 and 96 provide sites that sell products over the Internet and are enabled in accordance with the teachings of this disclosure. Thus, each server 94 and 96 has a site.xml file and a products.xml file. The servers 94 and 96 are registered sites with the server 98.

In step (1), as illustrated in FIG. 16, the user 90 is viewing the products provided by one of the sites 94 or 96 on a browser on the terminal 92 and selects a product of interest. In the illustrative example of FIG. 16, the user 90 selects a product with product ID 205. In step (2), the browser on the terminal 92 accesses the server 94 and examines the product.xml file. There it finds the product having product ID 205 and determines that there is a link to another web site 96. In step (3), the web site 94 accesses the web site 96 to gather the linked information. The linked information may be, for example, a description of the product generated by a manufacturer. In step (4), the web site 94 provides the information concerning the product to the terminal 92 and to the user 90.

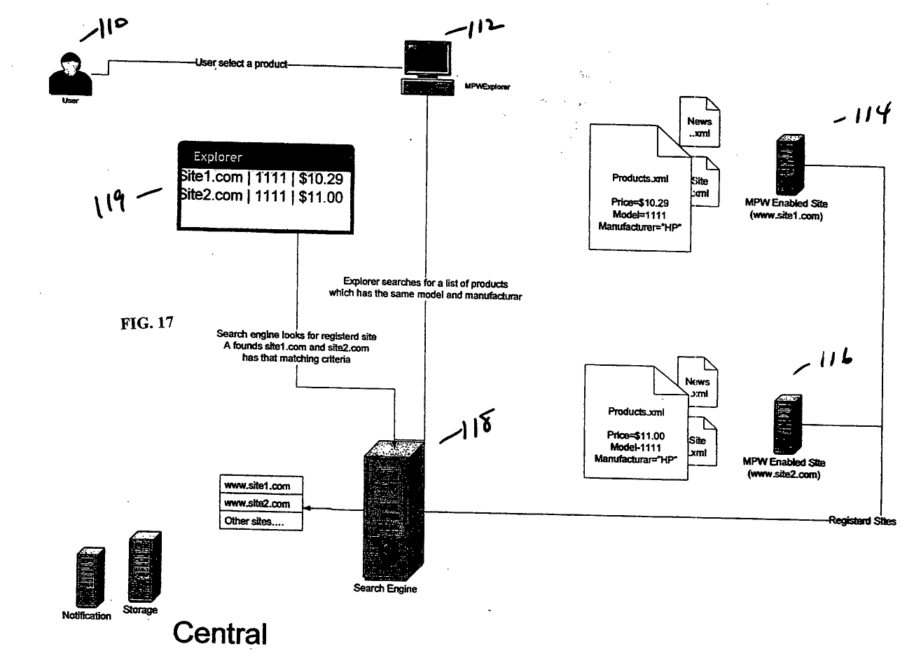

FIG. 17 illustrates another service provided by a web site in accordance with another aspect of the present invention. A user 100 selects a product in step (1) on a terminal 102. In step (2), a browser on the terminal 112 searches for a list of products that have the model number and the manufacturer specified by the user by transmitting a request to a Search Engine 118. In step (3), the Search Engine 118 requests information from a first registered site 114 and a second registered site 116. The first registered site 114 accesses its product list and provides a response to the Search Engine 118. The second registered site 116 also accesses its product list and provides a response to the Search Engine 118. In step (4) the Search Engine compiles a comparison, shown in 119, and sends it to the user's browser.

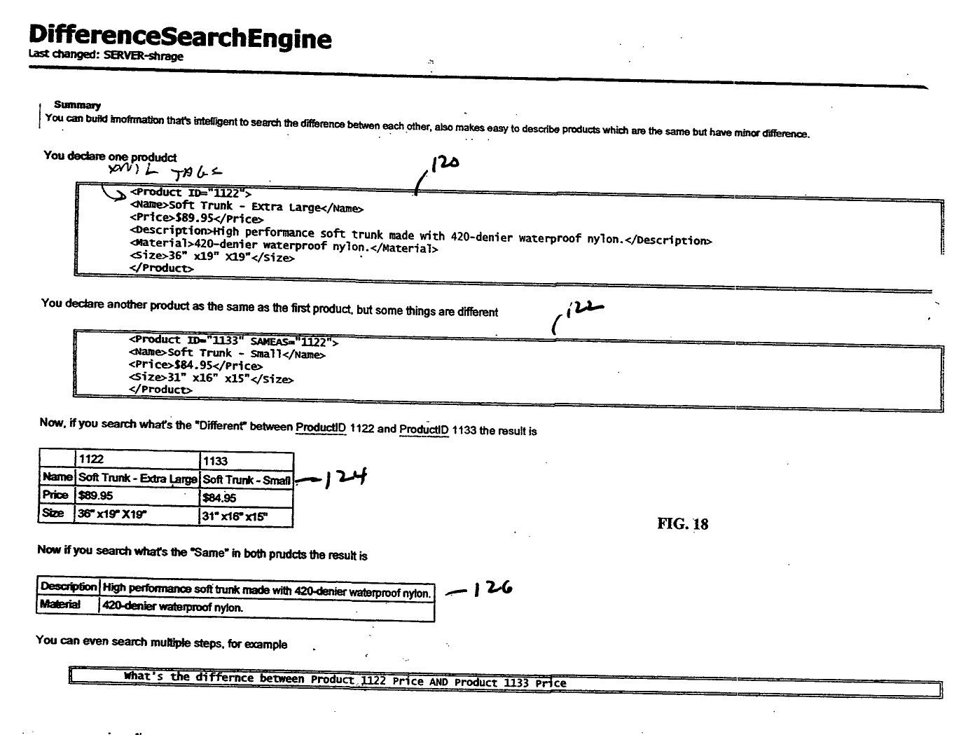

FIG. 18 illustrates a Difference Search Engine. In step 120, a first product is declared. In step 122, the same product is declared, but there are differences. In step 124, the differences are displayed. In step 126, the results that are the same are displayed.

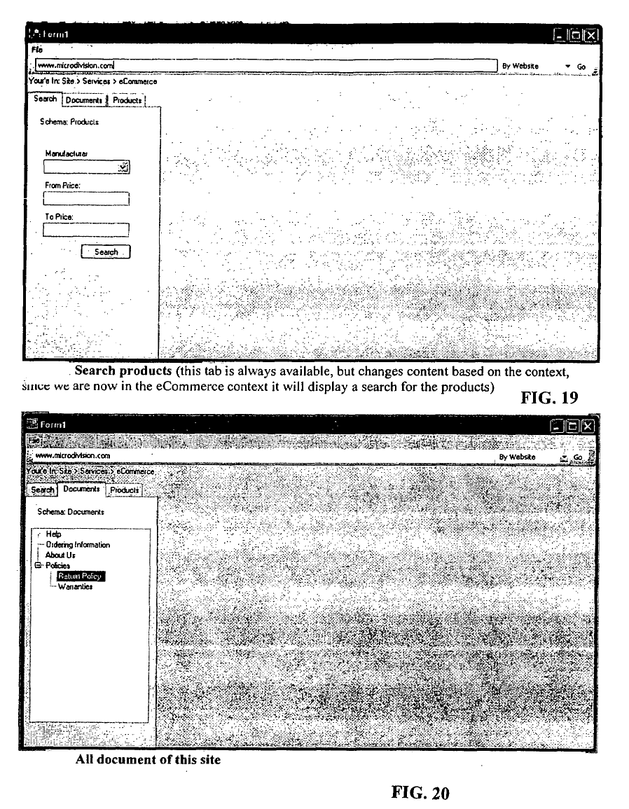

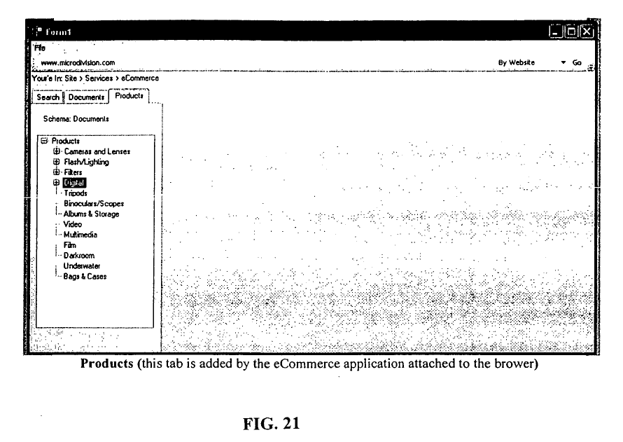

FIGS. 19 to 21 further illustrate a browser in accordance with one aspect of the present invention. FIG. 19 illustrates a search product tab. A user can enter a manufacturer, a From Price and a To Price. FIG. 20 illustrates a documents tab whereby a user can view important documents from a web site. The documents include a document explaining ordering information, an about us document, a return policy document and a warranty document. FIG. 21 illustrates a product tab. This tab can show information about products of interest to a user.

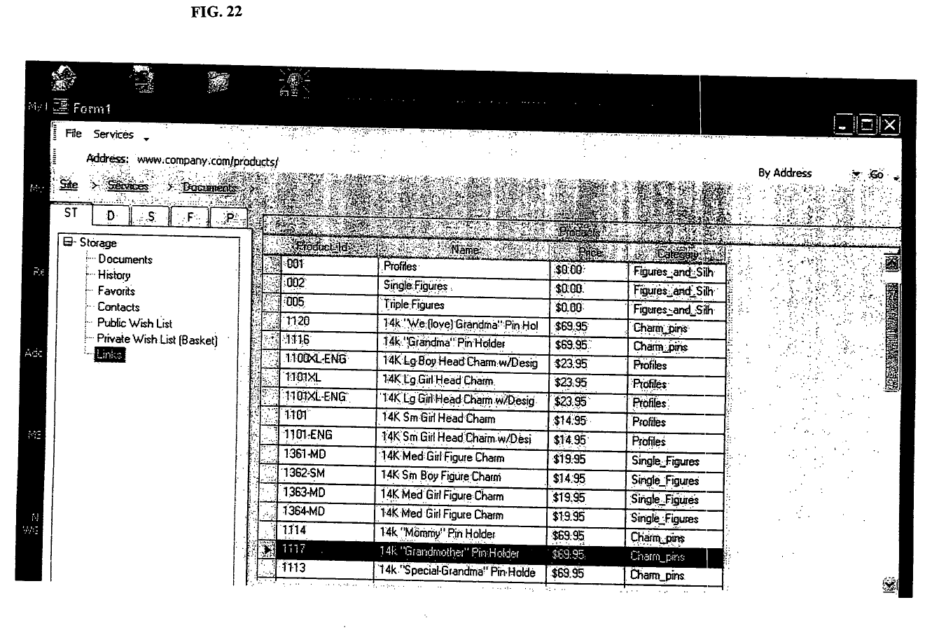

FIG. 22 illustrates a screen shot of another version of a browser. An address is specified in the top address box and the products available from that company are illustrated in the main box of the screen. The information concerning the products includes the product id, the product name, the price and a product category.

As can be seen on the left side of the screen, documents can be stored, a history of sites visited and information viewed can be stored, a favorites list can be stored, a contact list can be stored, and wish lists can be stored. The wish list can be a public wish list that is viewable by others or a private wish list for the user's own use.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A web site, comprising:
a processor;
a storage medium connected to the processor; and
one or more files in xml format that specify the web site, one or more types of services available at the web siteC, and, for each of the types of services, the specific services available.

2. The web site as claimed in claim 1, wherein the types of services include providing news and selling products.

3. The web site as claimed in claim 1, wherein the specific services include a list of a plurality of products available from the web site.

4. The web site as claimed in claim 3, wherein a description of each of the plurality of products is included in the specific services.

5. The web site as claimed in claim 1, comprising a file that specifies a type of software utility that can read the one or more files in xml format that specify the web site and one or more types of services available at the web site and that can read the one or more files in xml format that specify the specific services available for each of the types of services.

6. A method for a web site to communicate, comprising transmitting over the Internet one or more files in xml format that specify the web site, one or more types of services available at the web site, and, for each of the one or more types of services, the specific services available.

7. The method as claimed in claim 6, wherein the web site transmits the files in response to a request from another web site.

8. The method as claimed in claim 6, wherein the types of services include providing news, selling products, album listing, forums and messaging.

9. The method as claimed in claim 6, wherein the specific services include a list of a plurality of products available from the web site.

10. The method as claimed in claim 9, wherein a description of each of the plurality of products is included in the specific services.

11. The method as claimed in claim 6, comprising transmitting a file that specifies a type of software utility that can read the one or more files in xml format that specify the web site and one or more types of services available at the web site and that can read the one or more files in xml format that specify the specific services available for each of the types of services.

12. A computer that communicates with a web site, comprising:
a processor;
a storage medium that communicates with the processor;
a software application operable on the processor to:
send a request to the web site;
receive at least a portion of one or more files in xml format that specify the web site and one or more types of services available at the web site and receive at least a piece of one or more files in xml format that specify the specific services available for each of the types of services.

13. The computer as claimed in claim 12, wherein the types of services include providing news and selling products.

14. The computer as claimed in claim 12, wherein the specific services include a list of a plurality of products available from the web site.

15. The computer as claimed in claim 14, wherein a description of each of the plurality of products is included in the specific services.

16. The computer as claimed in claim 12, wherein the types of services includes selling products and the specific services includes a list of a plurality of products available from the web site and a description of each of the plurality of products is included in the specific services.

17. The computer as claimed in claim 16, further comprising a display and wherein the software application enables viewing of the list of plurality of products on the display.

18. The computer as claimed in claim 17, wherein the software application enables viewing of the description of each of the plurality of products on the display.

19. The computer as claimed in claim 17, wherein the software application enables the purchase of one or more of the plurality of products.

20. The computer as claimed in claim 17, wherein the software application creates a wish list from the plurality of products and stores the wish list in the storage medium.

21. The computer as claimed in claim 17, wherein the software application sorts the plurality of products and displays a sorted list of the plurality of products.

22. The computer as claimed in claim 17, wherein the software application filters the plurality of products and displays a filtered list of the plurality of products.

23. The computer as claimed in claim 17, wherein the software application is operable to:
send a second request to a second web site;
receive at least a portion of one or more files in xml format that specify a plurality of products available at the second web site and a description of each of the plurality of products available at the second web site;
create a comparison of the plurality of products available at the web site and the plurality of products available at the second web site.
